(19) United States
(12) Patent Application Publication
(10) Pub. No.: US 2005/0092755 A1
(43) Pub. Date: May 5, 2005

(54) Refrigerant cup for use with a container

(75) Inventors: Thomas J. Brown, Geneva, IL (US); Gary T. Mayberry, Elgin, IL (US)

Correspondence Address: MCANDREWS HELD & MALLOY, LTD, 500 WEST MADISON STREET, SUITE 3400, CHICAGO, IL, 60661, US

(73) Assignee: Cap and Seal Company, Inc.

(21) Appl. No.: 10/979,701

(22) Filed: Nov. 2, 2004

Related U.S. Application Data
(60) Provisional application No. 60/516,776, filed on Nov. 3, 2003.

(51) Int. Cl. B65D 51/16; F25D 3/00; F17C 1/00

(52) U.S. Cl. 220/581; 220/203.01

(57) ABSTRACT

A process for forming a metal cup having a pedestal, wherein the cup is mounted to a container carrying pressurized contents and the pedestal is to extend to a desired height to impede a slide-on clamp from engaging the cup. The process includes providing the cup, the container, filling the container with contents, sealing the cup about the container, the cup having a design such that the sealing process causes the pedestal to rise a first pedestal distance, pressurizing the contents such that the contents expand, the cup having a thickness such that, when the contents expand, the pedestal rises a second pedestal distance from such that the pedestal extends beyond a plane of the cup at least the minimum desired height in order that the pedestal at the desired height impedes the slide-on clamp being secured about the cup.

### RELATED APPLICATIONS

This application is related to, and claims priority from, Provisional Application No. 60/516,776, filed Nov. 3, 2003, titled “Refrigerant Cup For Use With A Container,” the complete subject matter of which is incorporated herein by reference in its entirety.

### BACKGROUND OF THE INVENTION

Embodiments of the present invention relate to a mounting cup, or blind refrigerant cup, for use with a canister containing a refrigerant for use in an automotive air conditioning system. More particularly, certain embodiments of the present invention relate to a refrigerant cup that rises during assembly with a container of refrigerant such that the refrigerant cup impedes the use of a slide-on can tap to be used with the refrigerant cup.

Pressurized liquids and gases, such as refrigerants for example, are often stored and sold in small containers that are sealed with a refrigerant cup. The conventional container is usually shaped like a can with a neck at the top and is provided with an opening at the neck encircled by an annular bead.

The conventional refrigerant cup is formed from coils or sheets of tin plated steel or any number of other metals or alloys. The refrigerant cup includes a cylindrical outer wall extending from a circular base to a peripheral rim and a cylindrical pedestal extending from the base concentrically with the outer wall. The peripheral rim includes a skirt that extends parallel to the outer wall such that the peripheral rim forms an inverted U-shaped or variation cross-section with the outer wall. The refrigerant cup is capable of being crimped or clinched to the annular bead located on the container to establish a seal between the refrigerant cup and the container.

A plastic or rubber sealing material such as a gasket is placed within the peripheral rim of the refrigerant cup between the outer wall and the skirt for insuring the sealing engagement between the peripheral rim of the refrigerant cup and the annular bead of the container. Dimples may be added to the outer wall of the refrigerant cup to retain the gasket within the interior space and/or to aid in the container-filling process.

During the cup forming process, the pedestal may be machined to have threads and thus be configured for connection to a can tap with corresponding threading. After the can tap is screwed onto, and sealed to, the pedestal, the top end of the pedestal is punctured by the can tap to access the contents of the container. A valve assembly housed inside the refrigerant cup may be substituted for the pierced-type arrangement with corresponding changes to the can tap device.

Typically, refrigerant cups are fabricated at a cup assembly plant and shipped to a filling plant where the refrigerant cups are placed in hoppers and eventually fed in an automated process to be sealed to the containers. During a typical under-the-cup assembly process, the container is sometimes partially filled with liquid. The refrigerant cups are then fed to the container by the automated process such that the peripheral rim of the refrigerant cup is placed upon the annular bead of the container with the sealing material disposed therebetween. The container is then positioned below a machine known in the art as a filling head, which lifts the cup off of the container by a vacuum to leave a narrow gap between the container and the cup. The filling head then draws a vacuum within the container through the gap. The filling head then pressurizes the container through the gap. In the case of refrigerant, the filling head adds the refrigerant to an empty, vacuumized container. Some products require oil, sealant, dye, or other additives prior to refrigerant charging. The filling head then deforms or crimps the refrigerant cup with an expanding collet to bring the peripheral rim and gasket of the refrigerant cup into sealing engagement with the annular bead of the container. The displacement of material caused by the crimping process may raise the pedestal up slightly, depending on the thickness and strength of the material.

Once the refrigerant cup is sealed to the container, the container is processed through a hot tank bath which significantly raises the temperatures of the can and its contents. In the case of Refrigerant 134a, the temperature reaches 130 degrees Fahrenheit and the pressure within the container reaches 208 psi. The changes in temperature and pressure within the container cause the contents to expand and push against the refrigerant cup and cause the pedestal to again “rise.”

In the case of certain substitutes for ozone depleting refrigerants such as Refrigerant 12, United States Environmental Protection Agency (EPA) regulations require the refrigerant cup to have certain additional features. The EPA has passed regulations to discourage attempts to mix car air conditioning system refrigerants because many of the available refrigerants react adversely with each other. Therefore, the EPA requires containers of refrigerant to be configured for use only with one specific kind of fitting, which, in turn, may be used only to fill the air conditioning systems of cars that are designed to use the corresponding refrigerant. Specifically, the EPA requires the refrigerant cups on containers of refrigerants to have a specific threading that corresponds to the threading of the specific can tap.

However, certain pre-existing slide-on clamps or fittings are available that may be connected to the refrigerant cup without engaging the specific threading. The clamps have a top surface connected to a continuous flange or series of flanges. The flanges are located a certain distance from the top surface and are used to wrap around the bottom of the refrigerant cup skirt such that the top surface is secured above the refrigerant cup. The clamps may then be connected to a non-regulated can tap that retrieves the contents without having to engage the threading on the refrigerant cup. This type of can tap could then be used to mix refrigerants in car air conditioning systems.

Therefore, the EPA has required that the refrigerant cups have certain features that impede attachment to the slide-on clamps. An example of such a refrigerant cup having a long skirt is shown in FIG. 1. The refrigerant cup 10a has a substantially flat base 14a with a peripheral rim 22a being integrally connected to the base by an outer wall 26a. The peripheral rim 22a includes a skirt 34a that curves away from the outer wall 26a and extends to a lower skirt plane 56a. A gasket 25a is retained within the peripheral rim 22a between the skirt 34 and the outer wall 26a. The refrigerant cup 10a further includes a cylindrical pedestal 38a formed therein. The top of the peripheral rim 22a is positioned along a horizontal plane 54a. The skirt 34a extends to the lower skirt plane 56a, which is located, by way of example, a distance of at least 0.155 inches from the horizontal plane 54a. Typically, the slide-on clamps cannot effectively be connected to the refrigerant cup having a skirt of 0.155 inches or more in length (i.e., a “long skirt”) because typically the flanges of the clamp are not long enough such that the flanges can slide under the skirt.

Additionally, for similar reasons, the clamps cannot effectively be connected to a refrigerant cup having a “bumped” pedestal. An example of such a refrigerant cup having a bumped pedestal is shown in FIG. 2. The refrigerant cup 10b has a similar structure to that of the refrigerant cup 10a of FIG. 1, however, the skirt 34b is shorter and the pedestal 38b extends more than, by way of example, 0.120 inches above the horizontal plane 54b of the peripheral rim 22b (i.e., a “bumped pedestal”).

The EPA's requirements for refrigerant cups create certain manufacturing and production problems, however. For example, as shown in FIG. 3, the long skirt 34a extends over the annular bead 78a leaving a small gap 21a which makes it more difficult for the filling head to effectively draw a vacuum within the container 66a and pressurize or fill the container 66a. Additionally, the filling head takes a longer time to completely fill or pressurize the container 66a because of the small gap 21a. Thus, the long skirt 34a slows down assembly and production. Also, the long skirt design tends to contribute to the gasket being blown out of the cup during under-the-cup filling.

Furthermore, “bumping up” the pedestal to an appropriate height by methods known in the art prior to the assembly of the refrigerant cup to the container causes the pedestal to be caught in the hopper and other assembly transportation means. Thus, the bumped pedestal slows down the automatic feeding process of the refrigerant cups onto the containers. Additionally, the step of bumping up the pedestal may need to be done in a manufacturing step separate from stamping, which slows down production speed.

Therefore, a need exists for an improved refrigerant cup that can meet EPA requirements but at the same time not slow down assembly and production time and also overcome the other deficiencies associated with conventional refrigerant cups.

### BRIEF SUMMARY OF THE INVENTION

Certain embodiments of the present invention include a process for forming a metal cup having a pedestal, wherein the cup is mounted to a container carrying pressurized contents and the pedestal is to impede a fitting from being effectively mounted to the cup, in compliance with United States Environmental Protection Agency requirements. The process includes forming a cup, wherein the forming step includes providing the cup with a base from which extends a pedestal and an outer wall having a peripheral rim aligned along a rim plane and from which extends a skirt. The pedestal extends to a first height from the base relative to the rim plane such that the pedestal does not impede the fitting from being mounted to the cup. The process further includes providing a container having an opening, placing the cup upon the container at the opening, filling the container with the contents, and sealing the cup about the container at the opening such that the pedestal rises a first pedestal distance from the base relative to the rim plane from the first height. The process further includes pressurizing the container such that the contents in the container expand and cause the pedestal to rise a second pedestal distance from the base relative to the rim plane such that the pedestal extends beyond the rim plane to a final height, wherein when the pedestal is at the final height, the pedestal impedes the fitting from being effectively mounted to the cup.

Certain embodiments of the present invention include a process for forming a metal cup having a pedestal, wherein the cup is mounted to a container carrying pressurized contents and the pedestal is to impede a fitting from being effectively mounted to the cup, in compliance with United States Environmental Protection Agency requirements. The process further includes forming a cup, wherein the forming step includes providing the cup with a base from which extends a pedestal and an outer wall having a peripheral rim aligned along a rim plane and from which extends a skirt. The skirt includes a bottom end aligned along a skirt plane. The rim plane and the skirt plane are separated by no more than a skirt distance such that the skirt does not impede the fitting from being mounted to the cup. The pedestal has a top end extending from the base to a first height proximate the rim plane such that the pedestal does not impede the fitting from being mounted to the cup. The process further includes feeding the cup from a hopper along an assembly transportation system to be placed on the container, providing a container having an opening, placing the cup upon the container at the opening, drawing a vacuum within the container and filling the container with the contents underneath the skirt, and sealing the cup about the container at the opening such that the pedestal rises a first pedestal distance from the base relative to the rim plane from the first height. The process further includes pressurizing the container such that the contents in the container expand and cause the pedestal to rise a second pedestal distance from the base relative to the rim plane such that the pedestal extends beyond the rim plane to a final height, wherein when the pedestal is at the final height, the distance between the bottom end of the skirt and the top end of the pedestal is such that the cup impedes the fitting from being effectively mounted to the cup.

Certain embodiments of the present invention include a cup for use with a container carrying pressurized contents, wherein, in compliance with United States Environmental Protection Agency requirements, the cup impedes a fitting from being effectively mounted to the cup. The cup includes a base from which extends a pedestal and an outer wall. The outer wall includes a peripheral rim being aligned along a rim plane, and the peripheral rim includes a skirt having a bottom end aligned along a skirt plane. The rim plane and the skirt plane are separated by no more than a skirt distance such that the skirt does not impede the fitting from being mounted to the cup. The pedestal extends to a first height from the base relative to the rim plane such that the pedestal does not impede the fitting from being mounted to the cup. The cup is configured to be sealed upon the container such that the pedestal rises a first pedestal distance from the base relative to the rim plane from the first height. The container sealed with the refrigerant cup is pressurized such that the contents in the container expand and cause the pedestal to rise a second pedestal distance from the base relative to the rim plane such that the pedestal extends beyond the rim plane to a final height, wherein when the pedestal is at the final height, the pedestal impedes the fitting from being effectively mounted to the cup.

### BRIEF DESCRIPTION OF SEVERAL VIEWS OF THE DRAWINGS

FIG. 1 illustrates a side sectional view of a prior art long skirt refrigerant cup.

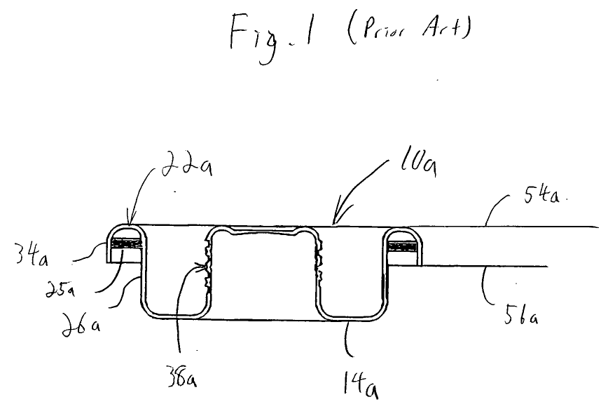

FIG. 2 illustrates a side sectional view of a prior art bumped refrigerant cup.

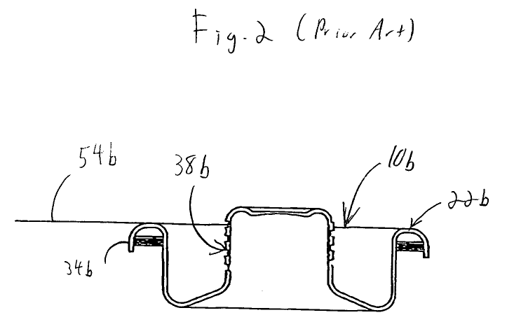

FIG. 3 illustrates a side sectional view of the prior art long skirt refrigerant cup of FIG. 1 attached to a container.

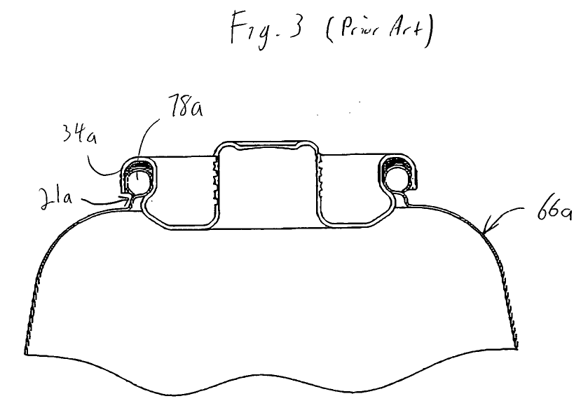

FIG. 4 illustrates a side sectional view of a refrigerant cup formed according to an embodiment of the present invention.

FIG. 5 illustrates a side sectional view of the refrigerant cup of FIG. 4 and a container formed according to an embodiment of the present invention.

FIG. 6 illustrates a side sectional view of the refrigerant cup and container of FIG. 5 where the refrigerant cup has been crimped to the container according to an embodiment of the present invention.

FIG. 7 illustrates a side sectional view of the refrigerant cup and container of FIG. 6 being passed through a hot water bath according to an embodiment of the present invention.

FIG. 8 illustrates a side section view of the refrigerant cup and container of FIG. 7 engaging a slide-on fitting.

FIG. 9 illustrates a side sectional view of the refrigerant cup of FIG. 5 being raised over the container of FIG. 5.

The foregoing summary, as well as the following detailed description of certain embodiments of the present invention, will be better understood when read in conjunction with the appended drawings. For the purpose of illustrating the invention, there is shown in the drawings, certain embodiments. It should be understood, however, that the present invention is not limited to the arrangements and instrumentalities shown in the attached drawings.

### DETAILED DESCRIPTION OF THE INVENTION

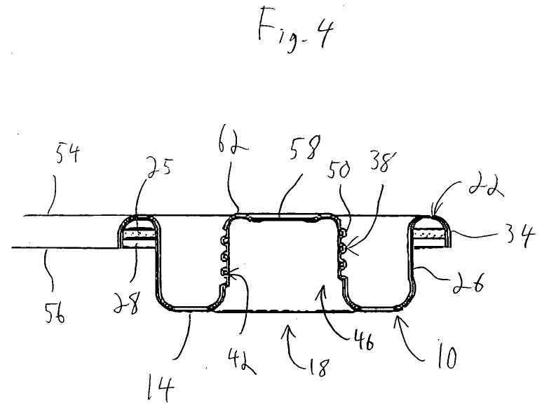

FIG. 4 illustrates a side sectional view of a refrigerant cup 10 formed according to an embodiment of the present invention. The refrigerant cup 10 is used to seal a container carrying pressurized contents. By way of example only, the refrigerant cup 10 is used to seal a container carrying Refrigerant 134a. Alternatively, the refrigerant cup 10 may be used to seal containers carrying other refrigerants, or any number of other pressurized contents. The refrigerant cup 10 is made of metal. By way of example, the refrigerant cup 10 is made of T-2 electrolytic tin plate. Alternatively, the refrigerant cup 10 may be made of aluminum or any number of other metals, alloys, laminates or coated materials. The refrigerant cup 10 is initially formed by being stamped from a metal sheet. By way of example only, the metal sheet may have a thickness of 0.0110 inches. Alternatively, the metal sheet may have a thickness in the range of 0.0090 to 0.0180 inches. Alternatively, the metal sheet may have other thicknesses.

The refrigerant cup 10 has a substantially flat base 14 disposed in a central area 18 with a peripheral rim 22 being integrally connected to the base 14 by an outer wall 26. The peripheral rim 22 includes a skirt 34 that extends outward from the outer wall 26 and that is formed integrally therewith. The skirt 34 curves away from the outer wall 26 and extends to a lower skirt plane 56. The skirt 34 is concentric with the outer wall 26 to define a gap 28. A gasket 25a is retained within the gap 28 between the skirt 34 and the outer wall 26a. The top of the peripheral rim 22 is positioned along a horizontal plane 54. The skirt 34 extends to the lower skirt plane 56, which is located, by way of example only, a distance of 0.115 inches from the horizontal plane 54. By way of example only, the distance between the lower skirt plane 56 and the horizontal plane 54 does not exceed 0.135 inches.

The refrigerant cup 10 further includes a cylindrical pedestal 38 formed in the central area 18. The pedestal 38 is formed by side walls 42, a top wall 58, and a curved top rim 62 that define an interior cavity 46 of the pedestal 38. The top wall 58 and top rim 62 that are generally positioned along the horizontal plane 54. Alternatively, the top rim 62 of the pedestal 38 may extend slightly beyond the horizontal plane 54, for example, by no more than 0.015 inches, or may be positioned slightly below the horizontal plane 54, for example, by 0.005 inches.

During the forming process, the pedestal 38 is machined to form threads 50 along the side walls 42 such that the pedestal 38 may be connected, i.e., screwed, to a can tap (not shown) which punctures the top wall 58 or opens an included valve to dispense the contents. Depending on the contents that the refrigerant cup 10 will be used to seal, the EPA requires specific threading patterns to be used on a refrigerant cup pedestal, and the threading patterns are to correspond only to a particular can tap. The can tap in turn may only be used in certain air conditioning systems that are prepared or manufactured for the contents of the particular container. In the case of Refrigerant 134a, specific threadings are required for use with only a particular can tap that can be used to fill car air conditioner systems that use Refrigerant 134a.

Alternatively, or additionally, the refrigerant cup 10 may be coated with an epoxy or other surface coatings on the top surface.

Once the refrigerant cup 10 is stamped and threaded, it may be transported for assembly with a container. Because the pedestal 38 does not extend very far beyond the horizontal plane 54 of the peripheral rim 22, if at all, the pedestal 38 does not cause the refrigerant cup 10 to be caught in hoppers or other carrying and transportation devices used in the assembly process. Thus, the reduced height of the pedestal 38 allows for easier and more efficient feeding of the refrigerant cup 10 through the hopper or any other assembly transportation system.

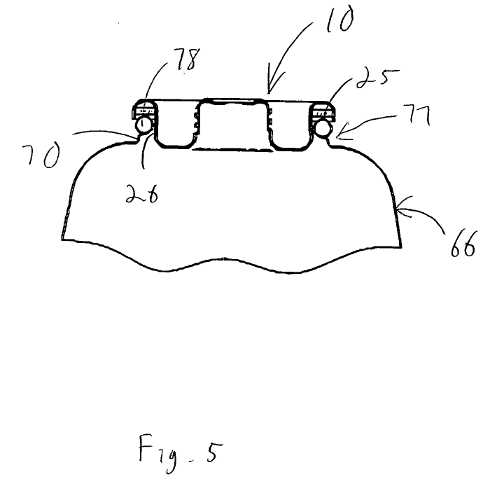

FIG. 5 illustrates a side sectional view of the refrigerant cup 10 of FIG. 4 and a container 66 formed according to an embodiment of the present invention. The container 66 is shaped like a typical can and has a neck 70 at a top end 77 and is provided with an opening at the neck 70 encircled by an annular bead 78. The container 66 may be made of tin plated steel, aluminum, or any number of other suitable metals or alloys. The refrigerant cup 10 has been placed on the container 66 such that the gasket 25 rests on the annular bead 78.

The container 66 may or may not be empty prior to the refrigerant cup 10 being placed thereon, depending on what product is to be carried within the container 66. If refrigerant, for example, Refrigerant 134a is the product, the container 66 is empty when the refrigerant cup 10 is added. If an additive product is to be carried in the container 66, then the additive is put in the container 66 prior to the refrigerant cup 10 being added.

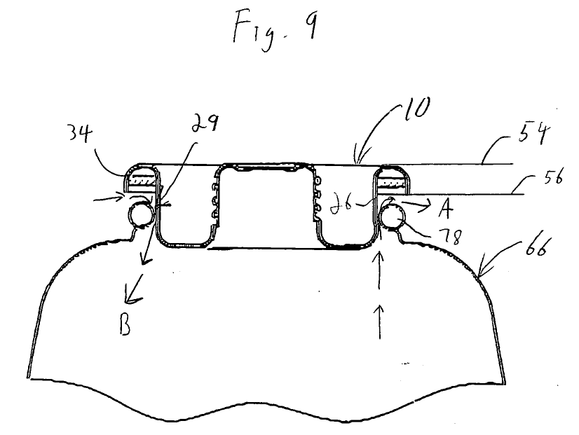

FIG. 9 illustrates a side sectional view of the refrigerant cup 10 being raised over the container 66. Once the refrigerant cup 10 is placed on the container 66, a filling head (not shown), uses a vacuum to lift the refrigerant cup 10 off of the container 66. By way of example only, the refrigerant cup 10 may be lifted 0.125 inches off of the container 66. The filling head then draws a vacuum within the container 66 by sucking the air out of the container through a gap 29 between the outer wall 26 and annular bead 78 as shown by the path of arrow A. Because the skirt 34 is “short,” the skirt 34 interferes less with the vacuum process. Thus, the process is faster and easier than if the skirt 34 was longer than, by way of example only, 0.155 inches from the lower skirt plane 56 to horizontal plane 54. Once the vacuum has been drawn in the container 66, the filling head, by methods known in the art, then pumps pressurized refrigerant into the container 66. The refrigerant is delivered into the container 66 through the gap 29 as shown by the path of arrow B. Again, the limited length of the skirt 34, allows for this process to be easier and faster than it would be for a longer skirt.

Returning to FIG. 5, once the container 66 has been filled with the pressurized product, the refrigerant cap is returned on top of the container 66 and the filling head uses a collet (not shown) to push the outer wall 26 outward and crimp the refrigerant cup 10 about the annular bead 78 of the container 66 such that the product is sealed within the container 66.

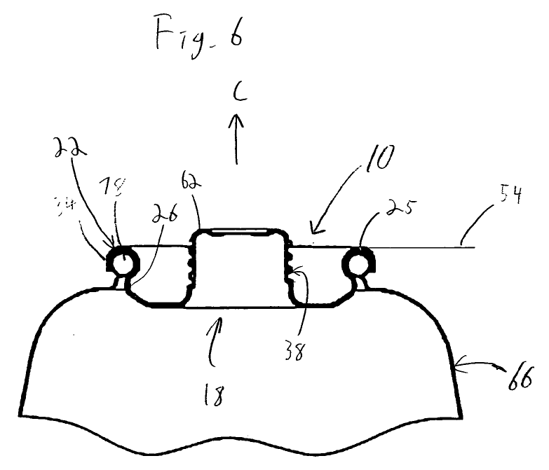

FIG. 6 illustrates a side sectional view of the refrigerant cup 10 and container 66 of FIG. 5 where the refrigerant cup 10 has been crimped to the container 66 according to an embodiment of the present invention. The crimping process deforms the refrigerant cup 10 in a number of ways. The outer wall 26 of the refrigerant cup 10 is pushed just under the annular bead 78 such that the skirt 34 and gasket 25 are pulled tightly about the annular bead 78 such that the gap 28 is eliminated. Thus, the skirt 34 is deformed to form a tight seal about the annular bead 78.

Furthermore, as the outer wall 26 is deformed just under the annular bead 78, the length of the outer wall 26 is reduced such that the thin, malleable metal is displaced toward the central area 18 of the refrigerant cup 10. The displacement of the material to the central area 18 causes the pedestal 38 to “rise up” in the direction of arrow C such that the top rim 62 of the pedestal 38 extends further above the horizontal plane 54. By way of example only, the pedestal 38 may rise a distance within the range of 0.025 inches to 0.050 inches. The distance the pedestal 38 rises depends on the thinness, hardness, shape, and ductility of the material and the type of the material. Depending on the desired rise of the pedestal 38, different materials of different thicknesses may be used.

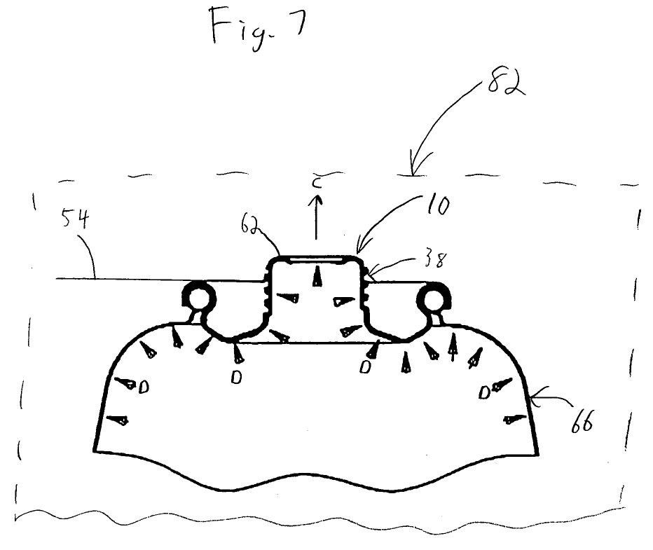

FIG. 7 illustrates a side sectional view of the refrigerant cup 10 and container 66 of FIG. 6 being passed through a hot water bath 82. Once the refrigerant cup 10 has been crimped and sealed to the container 66, the assembled container 66 is passed through the hot water bath 82. The container 66 and its contents are at a cold temperature prior to being passed through the hot water bath 82. By way of example only, the container 66 and its contents are typically at a temperature below 32 degrees Fahrenheit. The hot water bath 82 is maintained at, by way of example, 130 degrees Fahrenheit in accordance with DOT regulations. In the case of Refrigerant 134a, the container 66 is passed through a hot water bath 82 that is capable of heating the contents to a temperature of approximately 130 degrees Fahrenheit. As the container 66 passes through the hot water bath 82, the temperature of the product, in this case Refrigerant 134a, rises to at least 130 degrees Fahrenheit.

The pressure in the container 66 also rises as the temperature rises. For example, the pressure within the container 66 rises to approximately 208 psi at 130 degrees Fahrenheit. The arrows D indicate the pressure within the container 66 pushing outward against the walls of the container 66 and the refrigerant cup 10. Because the refrigerant cup 10 is made of an appropriate material at an appropriate thinness and shape (in the case of refrigerant 134a, the thinness and material is, by way of example, 0.009 to 0.013 inches thick T-2 electrolytic tin plate), the pressure pushes the pedestal 38 further upward in the direction of arrow C such that the top rim 62 rises to a desirable height. By way of example only, the pedestal 38 may rise upward a distance within the range of 0.070 inches to 0.105 inches. By way of example only, the desirable height may be at least in a range of 0.120 to 0.140 inches above the horizontal plane 54. Alternatively, the pedestal 38 may be configured to rise to any number of other desirable heights above the horizontal plane 54. Furthermore, where different pedestal heights are required for different products to provide a suitable impediment to the use of slide-on fittings, the type, thickness, and hardness of the material may be altered in conjunction with the properties of the product such that the pedestal 38 rises to the required height.

The container 66 is then removed from the hot water bath and is dried and packaged for shipping. The pedestal 38 remains in its “risen” position after removal from the hot water bath. In operation, a can tap is screwed onto the pedestal 38 to dispense the contents of the container into an appropriate air conditioning system. For example, in the case of Refrigerant 134a, the EPA requires the pedestal 38 to have a particular thread pattern that corresponds to a can tap for use only with cars that use Refrigerant 134a and have a special 134a fitting.

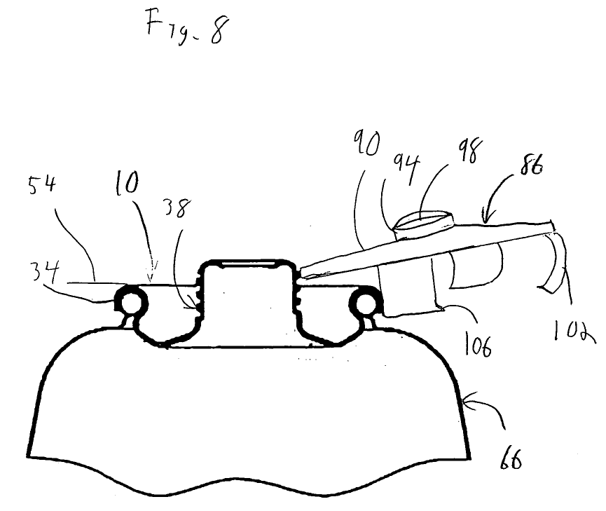

FIG. 8 illustrates a side section view of the refrigerant cup 10 and container 66 of FIG. 7 engaging a slide-on fitting 86. The slide-on fitting or clamp 86 can be used on conventional refrigerant cups to fit the can tap without engaging the unique threads of the refrigerant cup. The clamp 86 includes a circular top portion 90 with a raised cylindrical neck 94 having interior threads 98. The top portion 90 also includes legs 102 extending from a bottom side thereof. The legs 102 have flanges 106 that extend inward from the legs 102. In operation, the clamp 86 is positioned about, or mounted to, a conventional refrigerant cup such that the flanges 106 extend beneath the skirt of the refrigerant cup and the neck 94 is aligned above the pedestal. A can tap may then be screwed into the neck of the slide-on fitting without engaging the unique threads of the refrigerant cup 10 and tap the refrigerant cup 10 to dispense and possibly mix the contents of the container with another refrigerant type.

Therefore, the EPA requires that refrigerant cups used with any regulated refrigerants not only have a specific threading for use with a specific can tap, but also be structured to impede use with a slide-on clamp 86. The EPA requires that a refrigerant cup have either a long skirt, i.e., a skirt sufficient to impede the flanges of the slide-on clamp, or a raised pedestal, i.e., a pedestal sufficient to impede the flanges of the slide-on clamp. By extending the skirt or the pedestal, the clamp 86 cannot be positioned about the refrigerant cup because the legs 102 are not long enough for the flanges 106 to reach under the skirt. The refrigerant cup 10 of FIG. 8 has a pedestal 38 that extends over horizontal plane 54 by a distance of, by way of example only, more than 0.120 inches. This pedestal height prevents the clamp 86 from effectively being attached or mounted to the refrigerant cup 10 because the pedestal 38 pushes the top portion 90 of the clamp 86 to a position such that the flanges 106 cannot reach around the skirt 34. Thus, the rising pedestal 38 serves to fulfill EPA requirements to impede the use of slide-on fittings.

The material, thickness, temperatures, and pressures disclosed above are all examples of possible parameters for use in meeting pedestal height requirements for cans of Refrigerant 134a. In alternative embodiments, different parameters may be more appropriate for different canned refrigerants. For example, a thicker metal may be used where the pedestal does not need to be as high as it does for certain cans of refrigerant. Also, different pedestal diameters may be required with different refrigerants that require a pedestal having a different height. Different pedestal diameters require different heights to impede slide-on clamps. Additionally, different products may generate different pressures within the container during the hot water bath such that thicker or thinner materials or different cup shapes may be needed to achieve the desired amount of pedestal rise for that particular product. The material of the refrigerant cup, the thickness of the material, the hardness and ductility of the material, the product in the container, and the required pedestal height are all factors that are to be considered in relation to each other in practicing the embodiments of the invention.

The refrigerant cup of the various embodiments provides several benefits. First, the refrigerant cup is made with a short skirt, that is to say, the skirt does not extend from the horizontal plane to the lower skirt plane such a distance as to prevent a slide-on clamp from engaging the refrigerant cup. Thus, the short skirt does not interfere with the vacuum process or the filling process for the container as a longer skirt does. Therefore, the short skirt allows for faster and more efficient assembly and manufacturing time.

Furthermore, the process of assembling the refrigerant cup and the container is used to raise the pedestal to a desired height without having to deliver the refrigerant cup for assembly with the pedestal already at the desired raised or bumped height. By forming the refrigerant cup from an appropriate material at an appropriate thickness, the refrigerant cup uses the characteristics of the assembly process itself to “bump” or “raise” the pedestal during production such that the pedestal does not need to be bumped prior to production. The refrigerant cup is formed with the pedestal at a reduced height proximate the horizontal plane of the peripheral rim. Therefore, the refrigerant cup can be easily transported during the manufacturing and assembly process without the pedestal be caught or snagged on equipment along the way. Once the refrigerant cup is placed on the container, the thinness, shape, and ductility of the refrigerant cup allow for it to be substantially raised a first time during the crimping process. Then, later, the thinness, shape, and ductility of the refrigerant cup allow for it to be substantially raised again by the pressure formed within the container during the hot water bath step. The material and its thickness are determined such that the pressure in the can for a particular product causes the pedestal to raise to a desired height above the horizontal plane of the peripheral rim. Thus, the refrigerant cup of the different embodiments avoids production problems associated with a raised pedestal while at the same time accommodates the slide-on fitting obstruction requirements of the EPA for certain products.

While the invention has been described with reference to certain embodiments, it will be understood by those skilled in the art that various changes may be made and equivalents may be substituted without departing from the scope of the invention. In addition, many modifications may be made to adapt a particular situation or material to the teachings of the invention without departing from its scope. Therefore, it is intended that the invention not be limited to the particular embodiment disclosed, but that the invention will include all embodiments falling within the scope of the appended claims.

1. A process for forming a metal cup having a pedestal, wherein the cup is mounted to a container carrying pressurized contents and the pedestal is to impede a fitting from being effectively mounted to the cup, in compliance with United States Environmental Protection Agency requirements, comprising:
forming a cup, wherein said forming comprises providing the cup with a base from which extends a pedestal and an outer wall having a peripheral rim aligned along a rim plane and from which extends a skirt, the pedestal extending to a first height from the base relative to the rim plane such that the pedestal does not impede the fitting from being mounted to the cup;
providing a container having an opening;
placing the cup upon the container at the opening;
filling the container with the contents;
sealing the cup about the container at the opening such that the pedestal rises a first pedestal distance from the base relative to the rim plane from the first height; and
pressurizing the container such that the contents in the container expand and cause the pedestal to rise a second pedestal distance from the base relative to the rim plane such that the pedestal extends beyond the rim plane to a final height, wherein when the pedestal is at the final height, the pedestal impedes the fitting from being effectively mounted to the cup.

2. The process of claim 1, further including feeding the cup from a hopper along an assembly transportation system to be placed on the container, the pedestal extending to no more than the first height in order that the pedestal does not engage the hopper or assembly transportation system such that the cup is caught in the hopper or assembly transportation system.

3. The process of claim 1, wherein the skirt includes a bottom end aligned along a skirt plane, the rim plane and the skirt plane being separated by no more than a skirt distance such that the skirt does not impede the fitting from being mounted to the cup.

4. The process of claim 3, wherein the container includes a neck, the skirt extending no more than the skirt distance sits on the neck such that the container may have a vacuum drawn therein between the skirt and the neck and may be filled therein between the skirt and the neck.

5. The process of claim 3, wherein the skirt distance is within a range of 0.115 to 0.135 inches.

6. The process of claim 1, wherein at the first height, the pedestal extends from the base to a distance beyond the rim plane of no more than 0.015 inches.

7. The process of claim 1, wherein the filling step includes filling the container with refrigerant.

8. The process of claim 7, wherein the refrigerant is Refrigerant 134a.

9. The process of claim 1, wherein the cup is made of electrolytic tin plate.

10. The process of claim 1, wherein the cup is made of aluminum.

11. The process of claim 1, wherein the cup is stamped from a metal sheet having a thickness within a range of 0.009 to 0.018 inches.

12. The process of claim 1, wherein at the final height, the pedestal extends from the base to a distance beyond the rim plane, the distance being within a range of 0.120 to 0.140 inches.

13. The process of claim 1, wherein the fitting includes a top portion having a neck extending from a top side and flanges extending from a bottom side, the pedestal at the final height engaging the top portion such that the cup is prevented from being received between the flanges and the top portion such that the neck is positioned above the pedestal.

14. The process of claim 1, wherein said sealing step includes crimping the outer wall of the cup about the container at the opening.

15. The process of claim 1, wherein said pressurizing step includes passing the container with the cup through a hot water bath, the hot water bath increasing the temperature and the pressure of the contents such that the contents push the pedestal the second pedestal distance to the final height.

16. A process for forming a metal cup having a pedestal, wherein the cup is mounted to a container carrying pressurized contents and the pedestal is to impede a fitting from being effectively mounted to the cup, in compliance with United States Environmental Protection Agency requirements, comprising:
forming a cup, wherein said forming comprises providing the cup with a base from which extends a pedestal and an outer wall having a peripheral rim aligned along a rim plane and from which extends a skirt, the skirt including a bottom end aligned along a skirt plane, the rim plane and the skirt plane being separated by no more than a skirt distance such that the skirt does not impede the fitting from being mounted to the cup, the pedestal having a top end extending from the base to a first height proximate the rim plane such that the pedestal does not impede the fitting from being mounted to the cup;
feeding the cup from a hopper along an assembly transportation system to be placed on the container;
providing a container having an opening;
placing the cup upon the container at the opening;
drawing a vacuum within the container and filling the container with the contents underneath the skirt;
sealing the cup about the container at the opening such that the pedestal rises a first pedestal distance from the base relative to the rim plane from the first height; and
pressurizing the container such that the contents in the container expand and cause the pedestal to rise a second pedestal distance from the base relative to the rim plane such that the pedestal extends beyond the rim plane to a final height, wherein when the pedestal is at the final height, the distance between the bottom end of the skirt and the top end of the pedestal is such that the cup impedes the fitting from being effectively mounted to the cup.

17. The process of claim 16, wherein during said feeding step the pedestal extends to no more than the first height and the pedestal does not engage the hopper or assembly transportation system such that the pedestal is caught in the hopper or assembly transportation system.

18. The process of claim 16, wherein the skirt distance is within a range of 0.115 to 0.135 inches.

19. The process of claim 16, wherein at the first height, the pedestal extends from the base to a distance beyond the rim plane of no more than 0.015 inches.

20. The process of claim 16, wherein the filling step includes filling the container with a refrigerant.

21. The process of claim 20, wherein the refrigerant is Refrigerant 134a.

22. The process of claim 16, wherein the cup is made of electrolytic tin plate.

23. The process of claim 16, wherein the cup is made of aluminum.

24. The process of claim 16, wherein the cup is stamped from a metal sheet having a thickness within a range of 0.009 to 0.018 inches.

25. The process of claim 16, wherein at the final height, the pedestal extends from the base to a distance beyond the rim plane, the distance being within a range of 0.120 to 0.140 inches.

26. The process of claim 16, wherein the fitting includes a top portion having a neck extending from a top side and flanges extending from a bottom side, the pedestal at the final height engaging the top portion such that the cup is prevented from being received between the flanges and the top portion such that the neck is positioned above the pedestal.

27. The process of claim 16, wherein said sealing step includes crimping the outer wall of the cup about the container at the opening.

28. The process of claim 16, wherein said pressurizing step includes passing the container with the cup through a hot water bath, the hot water bath increasing the temperature and the pressure of the contents such that the contents push the pedestal the second pedestal distance to the final height.

29. A cup for use with a container carrying pressurized contents, wherein, in compliance with United States Environmental Protection Agency requirements, said cup impedes a fitting from being effectively mounted to said cup, comprising:
a base from which extends a pedestal and an outer wall, said outer wall including a peripheral rim being aligned along a rim plane, said peripheral rim including a skirt having a bottom end being aligned along a skirt plane, said rim plane and said skirt plane being separated by no more than a skirt distance such that said skirt does not impede said fitting from being mounted to said cup, said pedestal extending to a first height from said base relative to said rim plane such that said pedestal does not impede said fitting from being mounted to said cup;
said cup being configured to be sealed upon said container such that said pedestal rises a first pedestal distance from said base relative to said rim plane from said first height; and
said container sealed with said refrigerant cup being pressurized such that said contents in said container expand and cause said pedestal to rise a second pedestal distance from said base relative to said rim plane such that said pedestal extends beyond said rim plane to a final height, wherein when said pedestal is at said final height, said pedestal impedes said fitting from being effectively mounted to said cup.

30. The cup of claim 29, wherein said cup is stored in a hopper prior to being sealed to said container, said pedestal extending to no more than said first height in order that said pedestal does not engage said hopper such that said cup is caught in said hopper.

31. The cup of claim 29, wherein at said first height, said pedestal extends from said base to a distance beyond said rim plane of no more than 0.015 inches.

32. The cup of claim 29, wherein said contents include refrigerant.

33. The cup of claim 32, wherein said refrigerant is Refrigerant 134a.

34. The cup of claim 29, wherein said cup is made of electrolytic tin plate.

35. The cup of claim 29, wherein said cup is made of aluminum.

36. The cup of claim 29, wherein said cup is stamped from a metal sheet having a thickness within a range of 0.009 to 0.018 inches.

37. The cup of claim 29, wherein said skirt distance is within a range of 0.115 to 0.135 inches.

38. The cup of claim 29, wherein said cup includes a gasket within said peripheral rim.

39. The cup of claim 29, wherein said container includes a neck, said skirt extending no more than said skirt distance sits on said neck such that said container may have a vacuum drawn therein between said skirt and said neck and may be filled therein between said skirt and said neck.

40. The cup of claim 29, wherein at said final height, said pedestal extends from said base to a distance beyond said rim plane, said distance being within a range of 0.120 to 0.140 inches.

41. The cup of claim 29, wherein said fitting includes a top portion having a neck extending from a top side and flanges extending from a bottom side, said pedestal at said final height engaging said top portion such that said cup is prevented from being received between said flanges and said top portion such that said neck is positioned above said pedestal.
